(19) United States
(12) Patent Application Publication
(10) Pub. No.: US 2026/0159227 A1
(43) Pub. Date: Jun. 11, 2026

(54) System Architecture and Method for Deploying Maintenance Tasks by Adding a Secondary Function to Aircraft Cockpit Interfaces

(71) Applicant: EMBRAER S.A., São José dos Campos – SP (BR)

(72) Inventors: Juliano DE MELO LUSTOSA, São José dos Campos – SP (BR); Marcelo GALVÃO, São José dos Campos – SP (BR)

(21) Appl. No.: 18/971,455

(22) Filed: Dec. 6, 2024

(51) Int. Cl. B64C 13/18; B64D 45/00; B64F 5/40

(52) U.S. Cl. CPC B64C 13/18; B64D 45/00; B64F 5/40; B64D 2045/0085

(57) ABSTRACT

An aircraft operating method comprises receiving inputs from flight controls; responding to the inputs from the flight controls by providing control surface commands to control flight; and responding to alternative operation of the flight controls to select and perform an aircraft maintenance operation other than during flight.

### CROSS-REFERENCE TO RELATED APPLICATIONS

None.

### FIELD

The technology herein relates to aircraft control systems, and more particularly changes the manner that some maintenance activities such as sensors rigging (process of adjusting and setting up various control surfaces and sensors on an aircraft) or running Initiated Built-in Tests (“IBIT”; diagnostic features that allow the aircraft to perform self-tests and detect some faults or malfunctions in its systems) are deployed in aircraft.

### BACKGROUND

One or more mechanical, electrical and/or hydraulic linkages are typically used to connect the inceptor or yoke of an aircraft to a control surface such as an elevator, such that the control surface moves when the inceptor or yoke is operated by the pilot. Proper operation of the aircraft requires that there be a predetermined relationship between the inceptor/yoke position and the control surface position. For example, when the inceptor/yoke is in a neutral position, the control surface should also be in a neutral position. Similarly, control surface movements should track inceptor/yoke movement from neutral position to end-of-travel positions. Similar linkages enable the horizontal stabilizer to change position in response to the pilot pitch trim switch/control. Adjusting the parameters of the algorithm that translates electrical signals received through these linkages in actuator commands to achieve tracking and positional accuracy is often called “rigging”. Such rigging is a routine part of aircraft maintenance.

Currently, to carry out IBIT and rigging, it is necessary for many aircraft to use GSE (Ground Support Equipment) to communicate with other systems such as the flight control system. There are also some aircraft that use avionics interfaces to input commands to other systems and to receive from them their acknowledgement feedback using functional testing features built into the aircraft avionics. This is possible when the avionics system has functional testing features embedded. For this reason, that kind of solution requires integrated development between avionics and other aircraft systems. The communication between these systems generally is bidirectional (i.e., the capability to read and write in both senses), raising issues regarding the system's integration and other relevant discussions such as Cyber Security Risks.

In most other solutions, functional testing typically uses external gadgets such as laptops, cables, or tablets to connect to aircraft systems such as Flight Controls Computers (FCCs) and to be deployed. These gadgets called GSE become the interfaces used by maintenance crew to input commands to execute some maintenance tasks. Also, the GSE receive acknowledgement feedback from aircraft systems and display such results to maintenance personnel.

The GSE typically consists of a laptop running appropriate software, and communication cables. Requirements of such GSE can raise the following issues:
GSEs need to be developed and acquired by the operator.
The availability of GSE (laptop and cables) is determinant to the capability of executing the associated maintenance tasks.
The need for these actions may arise while the aircraft is landed in a remote location where

appropriate GSEs may not be available.
The GSE's operating system software becomes obsolete over the course of years (e.g. laptops using Microsoft Windows® as operating system).
Challenges associated to the configuration of laptop operating system regional settings (e.g. language, keypad, etc.) may impact proper functioning.
Purchasing GSEs increases the cost for aircraft customers (acquisition, storage and maintenance).
GSEs are exposed to software and hardware obsolescence (laptop operating system or its connectivity ports).
The current method requires GSEs and a setup in aircraft (operating system language, keyboard configuration, password, access to the aircraft's electronics bay, etc.).

### BRIEF DESCRIPTION OF THE DRAWINGS

FIG. 1 shows an example prior art flight control system.

FIG. 2 shows the FIG. 1 example flight control system connected to a prior art GSE.

FIG. 3 shows how using the technology herein including an enhanced flight control computer, the GSE is no longer necessary to perform certain maintenance tasks.

FIG. 3A shows an example aircraft using the below-described technology.

FIG. 4 show an example system control algorithm executed by the enhanced flight control computer under control of software instructions stored in non-transitory memory.

FIG. 5 shows an example more detailed control algorithm executed by the enhanced flight control computer under control of software instructions stored in non-transitory memory.

FIG. 6 shows a modified example architecture where the flight control computer provides unidirectional communication to a central maintenance computer supported human interface for rigging and IBIT testing.

FIG. 7 shows example aircraft controls.

FIG. 8 shows an example rigging mode selection diagram.

FIG. 9 shows an example IBIT mode selection diagram.

FIG. 10 shows an example flowchart of a user interface control process.

### DETAILED DESCRIPTION OF NON-LIMITING EMBODIMENTS

The current solution proposes a new architecture that uses some components already embedded in the aircraft, eliminating the need for GSE and reducing intra-systems dependence. In example embodiments, secondary functions are added to elements of Flight Controls systems primarily designed to fly the aircraft. The technology aggregates secondary functions to cockpit controls elements, making the aircraft capable of initiating these maintenance tasks without plugging in additional GSE.

Examples of cockpit controls elements are inceptors, switches and levers. But the technology herein is not be limited to these examples. The technology is considering any element present in the cockpit that was essentially installed in the aircraft to execute some kind of primary function in flight. However, while the aircraft is on ground and with their systems set to Maintenance Mode, other functions are associated with these components—enabling the execution of some maintenance tasks. To access these secondary functions, to enable them, a predefined sequence of inputs is used.

A video game player from the 90s could be an analogy. Players learned “secret” input combinations that would grant them access to secret levels in the classic Nintendo Super Mario World® or with the sequence of inputs required to do a special move in Mortal Kombat® 1. Others could find this similar to the act of pressing a few buttons on their digital wristwatch simultaneously for a significant amount of time and, in this way, accessing the date and time settings. Or some motor vehicles offer reprogramming modes for reprogramming electronic key fobs upon inputting special combinations of sensor inputs (e.g., accelerator pedal, door locks, etc.)

The technology herein comprises a system and method for carrying out maintenance tasks in aircraft embedded systems. All the examples described along the text are related to Flight Control Systems, but the technology can be replicated for other embedded systems that provide an interaction between Maintenance Technicians and LRUs (Line Replaceable Units), such as AFCS (autopilot) Auto Pilot ON/OFF switch, BCU (Braking Control Unit): WOW (weight on wheels) sensor or the like.

The examples described focus on IBIT and electronical rigging using Flight Control System parts whose primary functions are well known and clearly defined (example: the primary function of cockpit pilot pitch trim switch is commanding the horizontal stabilizer movement upwards or downwards) but adding a secondary function to them (example: the secondary function would be choosing the IBIT test to be executed on a predefined list of tests).

In one example arrangement, an aircraft cockpit comprising: controls; and a flight control system providing flight control laws, the flight control system responding to the controls by providing control surface commands to control flight; the flight control system comprising a flight control computer that responds to alternative operation of the controls to select and perform an aircraft maintenance operation other than during flight.

The flight control computer communicates unidirectionally with a further onboard computer system to provide feedback relating to the aircraft maintenance operation.

The further onboard computer system comprises a central maintenance computer including a display.

The controls comprise trim controls, pitch trim switches, flap selector lever, speed brake lever, control pedals, pilot's stick, etc. These examples are installed in the cockpit. Their use is convenient considering their ease of access.

The aircraft maintenance operation comprises rigging and/or testing.

The alternative operation of the controls comprises operating plural controls at the same time and/or operating plural controls each for longer periods than they are operated for flight and/or performing a first predetermined sequence of inputs to select between rigging or testing, and performing a second predetermined sequence of inputs to select between rigging and/or testing submodes.

The flight control computer responds to an additional alternative operation of the controls to stop performing the aircraft maintenance operation.

In another aspect, an aircraft operating method comprises receiving inputs from flight controls; responding to the inputs from the flight controls by providing control surface commands to control flight; and responding to alternative operation of the flight controls to select and perform an aircraft maintenance operation other than during flight.

Unidirectional communication may provide feedback relating to the aircraft maintenance operation.

The flight controls comprise trim controls, pitch trim switches, flap selector lever, speed brake lever, control pedals, pilot's stick, etc. These examples are installed in the cockpit. Their use is convenient considering their ease of access.

The aircraft maintenance operation comprises rigging and/or testing.

The alternative operation of the controls comprises operating plural controls at the same time and/or operating plural controls each for longer periods than they are operated for flight and/or performing a first predetermined sequence of inputs to select between rigging or testing, and performing a second predetermined sequence of inputs to select between rigging and/or testing submodes.

Responding to an additional alternative operation of the controls may stop performing the aircraft maintenance operation.

In another aspect, a non-transitory memory storing instructions that when executed by at least one processor and/or processing circuit, controls the at least one processor and/or processing circuit to perform operations comprising: receiving inputs from flight controls; responding to the inputs from the flight controls by providing control surface commands to control flight; and responding to alternative operation of the flight controls to select and perform an aircraft maintenance operation other than during flight.

The operations further comprise communicating unidirectionally to provide feedback relating to the aircraft maintenance operation.

The flight controls comprise trim controls, pitch trim switches, flap selector lever, speed brake lever, control pedals, pilot's stick, etc. These examples are installed in the cockpit. Their use is convenient considering their ease of access.

The aircraft maintenance operation comprises rigging and/or testing.

The alternative operation of the controls comprises: operating plural controls at the same time and/or operating plural controls each for longer periods than they are operated for flight, and/or performing a first predetermined sequence of inputs to select between rigging or testing, and performing a second predetermined sequence of inputs to select between rigging and/or testing submodes.

### Example System

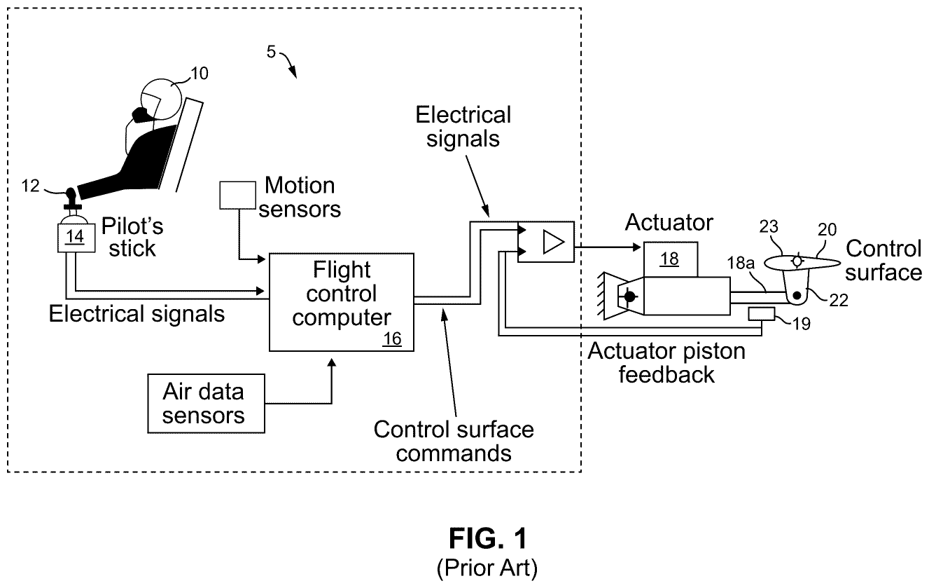

So, let's imagine the following picture representing a typical fly-by-wire Flight Control System 5 shown in prior art FIG. 1. In this example diagram, an aircraft pilot 10 within a cockpit operates a stick 12, which causes an actuator/transducer 14 to produce electrical signals. The pilot's stick 12 and actuator/transducer 14 are electrically connected to the Flight Control Computer (FCC) 16. When the pilot moves the stick 12, it produces electronic signals transmitted to Flight Control Computer 16. There the signals are converted from analog to digital signals and used by the flight control software and control laws stored in non-transitory memory within the FCC and used to control operations of at least one processor and/or processing circuit with the FCC) to calculate the actuator commands for output such as during aircraft flight. Also, in the Flight Control Computer 16 these commands are converted from digital to analog. The resulting analog electrical signal is then transmitted to the actuator 18 where it is converted to mechanical movements on a mechanism that, in the end, results in moving the aircraft flight control surface 20. For example, in this case, actuator 18 comprises a linear actuator with a piston 18a that is connected to a bellcrank 22 fixed to a rotatable aircraft part 23 such as a aileron that provides the movable control surface 20. Thus linear movement of piston 18a causes control surface 20 to rotate, thereby in flight controlling an aspect of the flight of the aircraft such as a rotation of the aircraft.

In such example, the Electronic Rigging consists of adjusting parameters used on control loop equations that convert analog to digital signals (or vice-versa) in Flight Control Computer 16 to make the system understand when the Pilot's Stick 12 is positioned in neutral (not demanding control surface movement), or when it is positioned out of neutral (demanding surface movement in a specific direction that would, for example, pitch the aircraft up or down). Also, the Electronic Rigging is necessary to define the magnitude of the electrical signals necessary for the actuator 18 to be positioned in neutral or to define how much displacement the control loop is requiring between neutral and its mechanical stops. For safety reasons, Electronic Rigging is supposed to be done while the aircraft is on ground and stopped, and while the Flight Controls System 5 is set by maintenance crew to Maintenance Mode or Ground Tests Mode. The parameters defined during Electronic Rigging are stored in non-volatile memory in Flight Control Computer 16 and recovered from there in every power up.

Keeping the same FIG. 1 picture in mind, let's now explain the Initiated Built-in Tests (or simply IBIT Tests) Execution. They are diagnostic features that allow the Flight Control System 5 to perform self-tests and detect some faults or malfunctions in its components. Their algorithms are implemented in Flight Control Computer 16. As well as for Electronic Rigging, IBIT Tests are supposed to be executed while the aircraft is on ground and stopped, and while the Flight Controls System 5 is set by maintenance crew to Maintenance Mode or Ground Tests Mode. The algorithms may result in influencing volatile or non-volatile variables depending on each case. Volatile effects are removed when the Flight Control Computer 16 is powered down.

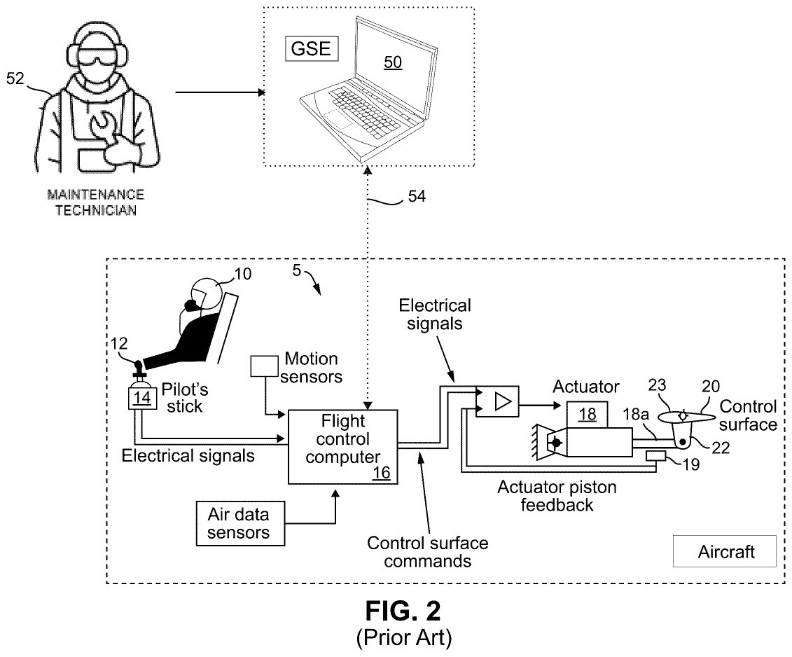

For the two maintenance tasks just described in previous paragraphs (Electronic Rigging and IBIT Tests Execution), the state of the art is represented by prior art FIG. 2. Pay attention that this picture introduces a representation of a laptop 50 named GSE (acronym for Ground Support Equipment) to become the interface used by Maintenance Technician 52 to input commands for the Flight Control Computer 16 to deploy those maintenance tasks. The same interface is used to receive from Flight Control System 5 the acknowledgement feedback. Gadgets other than a laptop 50 can be used such as for example a tablet or Aircraft Avionics System such as EICAS. The connection 54 between GSE 50 and Flight Control Computer 16 may be physical using cables or by wireless communications such as WiFi, depending on the system architecture. The main point here is that the Flight Control Computer 16 requires external elements (hardware or software) connected and bidirectionally communicating to it by the Maintenance Technician 52 to perform these tasks.

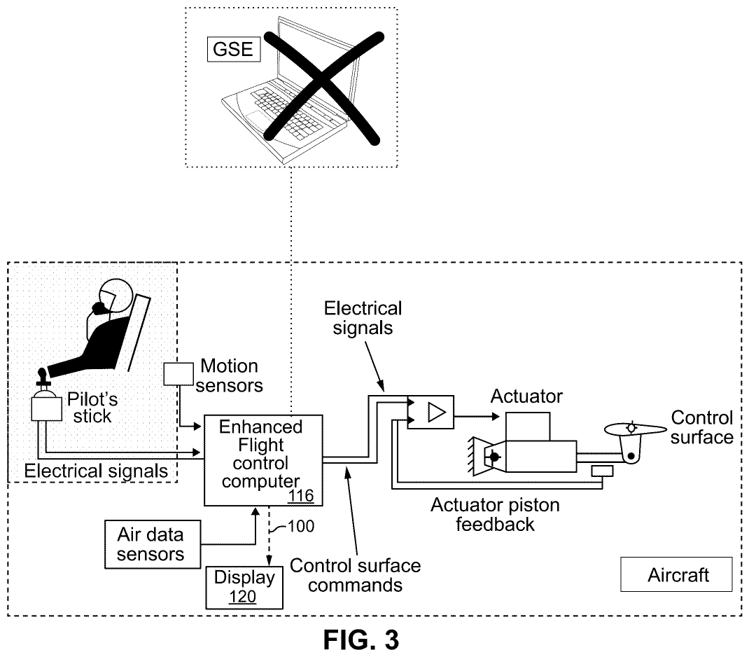

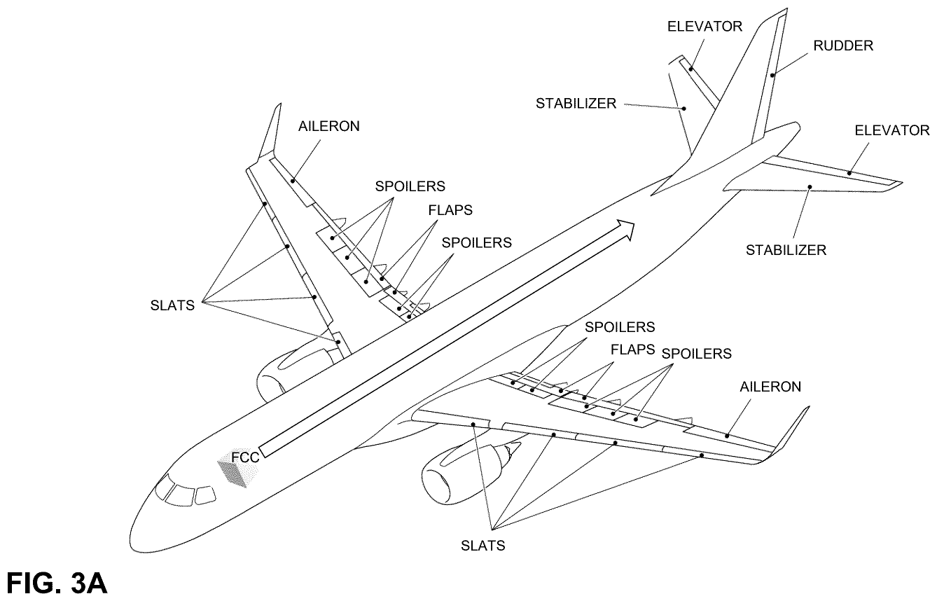

As FIG. 3 shows, the present technology eliminates the GSE 50 by enhancing the functionality of the FCC 116, and FIG. 3A shows an example aircraft including such FCC and associated fly-by-wire technology the enhanced FCC controls the control surfaces of. At least to input data to the Flight Control Computer 116, a GSE 50 is not necessary anymore. Otherwise, to receive data from the Flight Control Computer 116, some kind of interface 100 is still used to provide a user interface of some sort with human feedback (such as pass or fail message) to Maintenance Technician 52.

Such communication 100 between the enhanced Flight Control Computer 116 and some kind of solution 120 to read and display data represents a unidirectional communication. Therefore, the Flight Control Computer 116 is not consuming inputs from that. It is providing outputs. And then, an aircraft system like the CMC (Central Maintenance Computer) can be used to read and display data. It is a system that collects and stores maintenance data for aircraft systems. It monitors aircraft systems for faults, handles fault information, and supplies maintenance messages.

The Flight Control Computer 116 starts its algorithms related to Electronic Rigging or IBIT Tests Execution by adding to Flight Control System 5 components a secondary function. They already have interface with the Flight Control Computer 116, and they can provide input signals to this computer. Some examples present in aircraft are pitch trim switches, flap selector lever, speed brake lever, control pedals, pilot's stick, etc. These examples are installed in the cockpit. Their use is convenient considering their ease of access.

This is supposed to be done while the aircraft is on ground and stopped, and while the Flight Controls System 5 is set by the Maintenance Technician 52 to a special Maintenance Mode or Ground Tests Mode (in other words, in a mode Not for Flight). Once in this mode, these secondary functions are enabled on these Flight Control System 5 Components if the Maintenance Technician 52 performs in cockpit some predefined sequences of inputs used as interlocks, like a key, to activate these hidden functions.

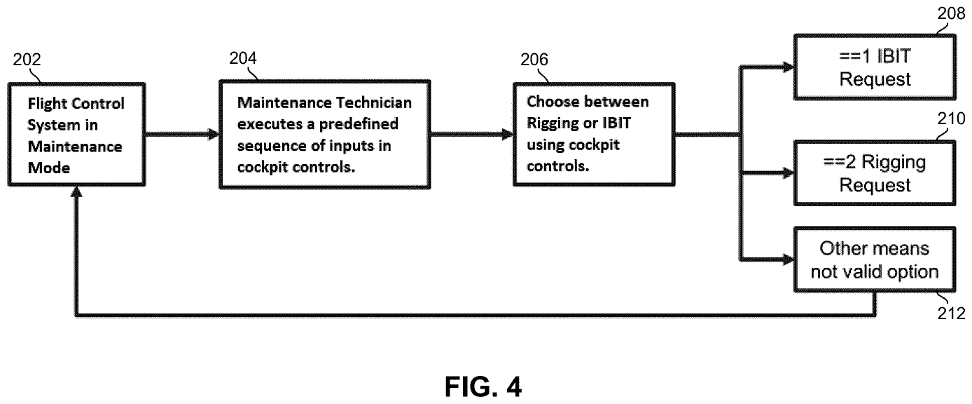

FIG. 4 is a schematic representation of this access. In this diagram, the flight control system 5 is placed in maintenance mode (block 202), and the maintenance technician 52 then executes a predefined sequence of inputs (block 204) using existing cockpit controls intended for another use/purpose (e.g., some aspect of controlling flight of the aircraft). There can be plural predefined sequences, e.g., a first predefined sequence to select rigging and a second predefined sequence to perform IBIT (block 206). If the technician performs the first predefined sequence, the system enters the rigging mode (block 210). If the technician performs the second predefined sequence, the system enters the IBIT mode (block 208). If the technician performs an erroneous sequence, the system may indicate an invalid input (block 212).

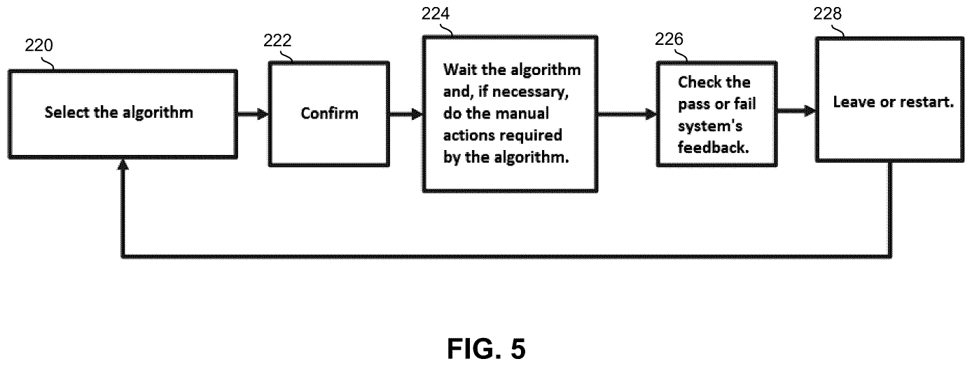

Once Electronic Rigging or IBIT Tests are selected (block 202), then the Maintenance Technician selects which is the algorithm that he is going to execute (block 220 of FIG. 5). In other words, which sensor or surface he wants to rig (block 210) or which IBIT test he wants to run (block 208). The technician then waits for the algorithm to be performed and if needed by the algorithm, provide manual actions (e.g., move the stick to a particular position) the algorithm needs to do its job (block 224). The system may then indicate pass or fail through an appropriate user feedback mechanism (described below) (block 226). The algorithm may then leave or restart as appropriate (block 228).

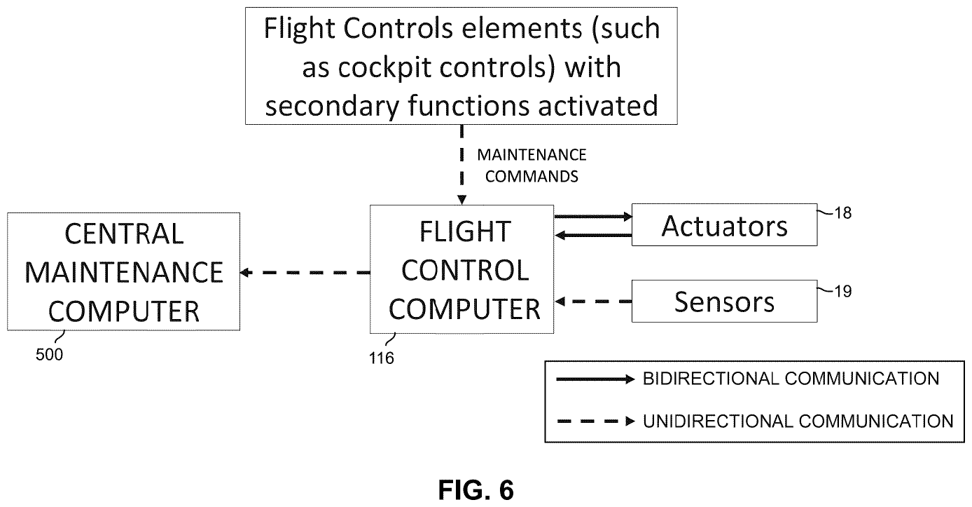

FIG. 6 summarizes example intercommunication advantages. Please pay special attention to the sense of communication between the Flight Control Computer 116 and other interfaces. This is an advantage in the context of Cyber Security because the Flight Control Computer 116 is not receiving inputs from another computer that could be running malicious algorithms. Understand that in this example embodiment, any development used to run the algorithms related to Electronic Rigging or IBIT Tests Execution is contained in Flight Control Computer 116 Logics because there are allocated the logics supposed to interpret other system components (e.g., the controls 502 and the central maintenance computer 500) performing secondary functions.

### Example Implementation

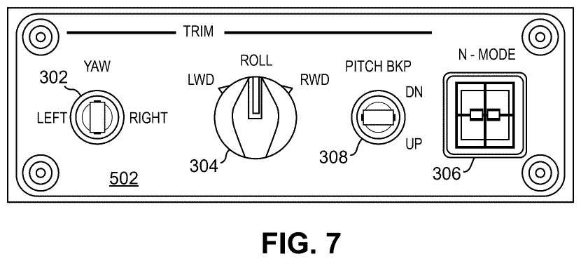

Now let's give an example implementation in connection with FIG. 7. Imagine that the following interface 502 is available in cockpit in a hypothetical aircraft.

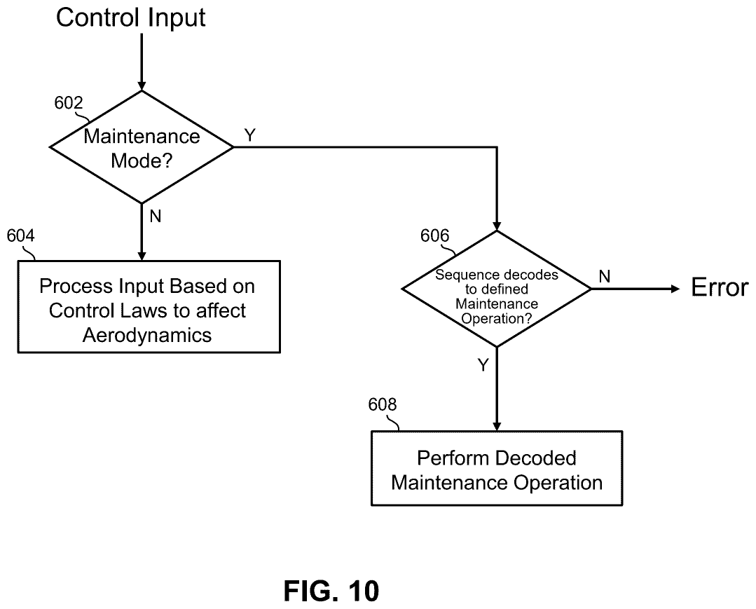

From the left to the right, these buttons have the following primary functions:
Yaw Trim Switch 302: moves rudder or rudder's trim tab to adjust its neutral position (where the aircraft yawing moment is equal to zero). For example, the Yaw trim is accomplished by an electromechanical actuator, which receives signals from the yaw trim switch 302. In one example aircraft, continuous command of the yaw trim switch 302 is limited to 3 seconds, even if the trim switch is actuated longer than 3 seconds. As a result, when manually actuating the trim, it is necessary to release the switch after a 3-second actuation, then actuate it again to continue the trim command. This feature intends to minimize the effects of an inadvertent trim command failure. Yaw trim position is presented on EICAS display. A quick-disconnect button installed on the control wheels allows, while kept pressed, disconnecting the yaw trim.
   Roll Trim Switch 304: moves the aileron or aileron's trim tab to adjust its neutral position (where the aircraft rolling moment is equal to zero). In one example aircraft, the roll trim switch 304 (which is spring loaded to neutral) is pressed left or right to actuate roll trim to roll left or right, respectively. Roll trim is indicated by a roll trim position indicator (e.g., a green pointer moving on a white semicircle scale, where the center of the scale is zero trimming).
   Pitch Trim Backup Switch 308: moves the elevator or elevator's trim tab to adjust its neutral position (where the aircraft pitching moment is equal to zero). This switch is called backup because it is a redundancy to those installed in pilot's and copilot's sticks. In one embodiment, as the airplane slows, the pilot can retrim in pitch using a TCS button on the sidestick. Press the button, and the airplane will trim to the airspeed that exists before the button is activated.
   Normal Mode Switch 306: used to revert the flight control system mode between Normal and Direct Mode. (In normal mode, flight control laws automatically provide flight envelope protection and auto-trim functions including automatic roll compensation in a sideslip; in direct mode, there is no envelope protection and the aircraft will respond directly to the pilot-provided inputs). The above controls may thus be operated as described during flight of the aircraft to control the flight of the aircraft (FIG. 10, blocks 602, 604). These controls are just non-limiting examples any element in the cockpit capable of providing inputs to the FCC may be used because the algorithms embedded in FCC can interpret them differently depending on the situation.

Now assume that the flight control system is set to Maintenance Mode. Typically, there is a manually operable switch in the aircraft dedicated to set this mode. Also, it is expected that, while into this mode, a caution message MAINTENANCE MODE is displayed because it is NOT FOR FLIGHT. This switch is operated only when the aircraft is on the ground and is not in flight.

Once in Maintenance Mode (FIG. 10, “Y” exit to decision block 606), the technician 52 may activate one of the following submodes (FIG. 10, block 606): Rigging or IBIT.

To access these submodes (where secondary functions are enabled to some flight control system components), a predefined sequence of inputs is used. So, taking the example of the buttons previously described, imagine an example such as:

Move Yaw Trim Switch 302 to the right and Roll Trim Switch 304 to the left and hold both at these positions for at least 15 seconds.
Release them and click twice the Normal Mode Switch 306. The above operation will generally never be performed while the aircraft is in flight. Specifically, the flight crew might adjust yaw trim or roll trim while in flight, but would generally not adjust them both at the time. Furthermore, as noted above, the flight crew would not hold these controls out of their neutral positions for 15 seconds or more (for example, continuous command of the yaw trim switch 302 for yaw trim may be limited to 3 seconds). Thus, the chance extremely low that normal operation of these controls during flight could be mistaken by the FCC 116 for selecting a maintenance mode.

This example is totally hypothetical, and many other combinations or other interfaces could be used. They preferably are sufficiently peculiar to identify the intention of the Maintenance Technician to access one of the submodes and which of them. Once the submode has been engaged and limiting the example to the buttons described, now the secondary functions of the buttons might perform a decoded maintenance operation (FIG. 10, block 608) such as:

In Rigging Submode: selecting the sensor or surface to rig, defining the magnitude of the rigging offset, confirming the choices (by pressing N-Mode), recording the rigging offset into Flight Control Computer non-volatile memory, etc.
In IBIT Submode: selecting the IBIT algorithm, starting the algorithm execution, aborting the algorithm execution (by pressing N-Mode), etc.

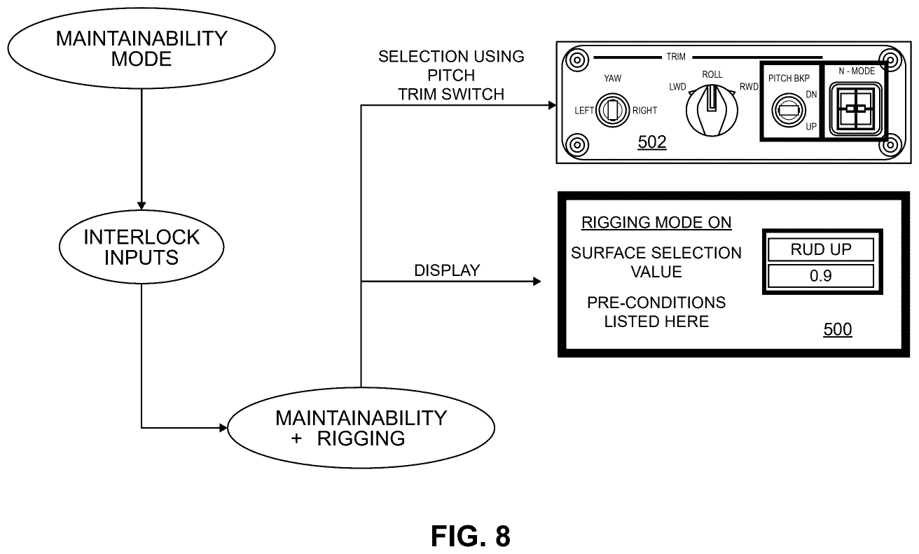

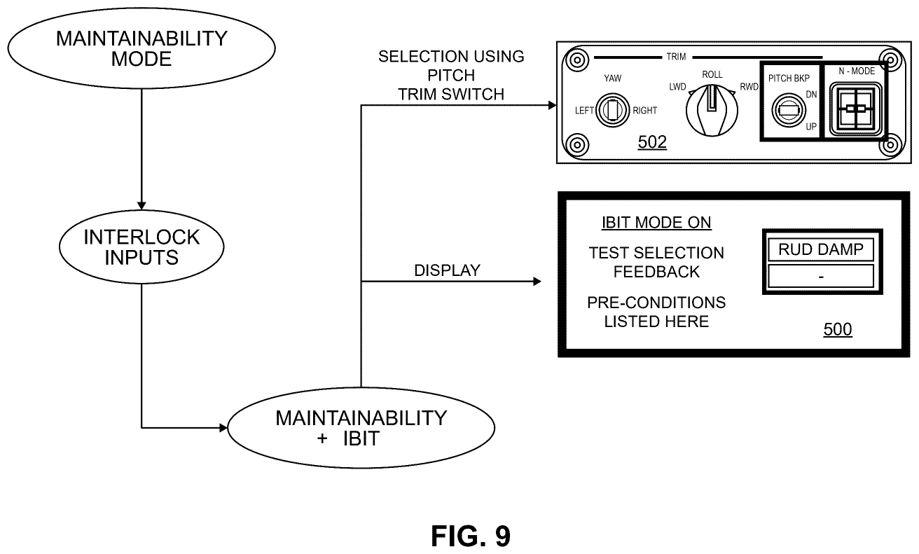

FIGS. 8 & 9 may help to understand the example. Pay attention to the representation of a hypothetical Central Maintenance Computer 500 acting as the Human-Machine Interface. (Using the maintenance computer is convenient since it is possible to customize the screens with relatively small effort, but in other embodiments, other cockpit display systems such as EICAS could be used alternatively or in addition). In the FIG. 8 example, the technician operates the pitch trim switch to select a rudder up rigging mode with a surface selection value of 0.9. In the FIG. 9 example, the technician operates the pitch trim switch to test the rudder dampening.

The proposed technology herein brings to the aircraft operation many advantages. Some of them are listed below:

From the operator perspective, it enables the execution of Rigging or IBIT activities at any point of the Globe. In other words, it is not necessary to have the aircraft in a Maintenance Center with some infrastructure available.
Reduces the TAT (Turn Around Time is the time that the aircraft takes to complete a process or task on the ground, from the moment it starts to when it's finished, and then become available for next flight).
Maintenance costs are reduced considering that GSE is not necessary (non-recurrent cost) and considering the independence of infrastructure of a Maintenance Center to execute the tasks (recurrent cost).

Typically, the other solutions (state of the art) which require the use of GSE are planned tasks by the operator. That means the GSE is supposed to be available for the execution of the tasks. It is not frequent, but sometimes the GSE is unavailable for any reason (including computer bugs, low battery, etc.) and when this kind of matter happens, it has a high impact on the aircraft availability.

[All patents and publications cited herein are incorporated by reference as if expressly set forth.]

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An aircraft cockpit comprising:
controls; and
a flight control system providing flight control laws, the flight control system responding to the controls by providing control surface commands to control flight;
the flight control system comprising a flight control computer that responds to alternative operation of the controls to select and perform an aircraft maintenance operation other than during flight.

2. The aircraft cockpit of claim 1 wherein the flight control computer communicates unidirectionally with a further onboard computer system to provide feedback relating to the aircraft maintenance operation.

3. The aircraft cockpit of claim 2 wherein the further onboard computer system comprises a central maintenance computer including a display.

4. The aircraft cockpit of claim 1 wherein the controls comprise trim controls and/or pitch trim switches and/or flap selector lever and/or speed brake lever and/or control pedals and/or pilot's stick.

5. The aircraft cockpit of claim 1 wherein the aircraft maintenance operation comprises rigging and/or testing.

6. The aircraft cockpit of claim 1 wherein the alternative operation of the controls comprises operating plural controls at the same time and/or operating plural controls each for longer periods than they are operated for flight.

7. The aircraft cockpit of claim 1 wherein the alternative operation of the controls comprises performing a first predetermined sequence of inputs to select between rigging or testing, and performing a second predetermined sequence of inputs to select between rigging and/or testing submodes.

8. The aircraft cockpit of claim 1 wherein the flight control computer responds to an additional alternative operation of the controls to stop performing the aircraft maintenance operation.

9. An aircraft operating method comprising:
receiving inputs from flight controls;
responding to the inputs from the flight controls by providing control surface commands to control flight; and
responding to alternative operation of the flight controls to select and perform an aircraft maintenance operation other than during flight.

10. The aircraft operating method of claim 9 further including communicating unidirectionally to provide feedback relating to the aircraft maintenance operation.

11. The aircraft operating method of claim 9 wherein the flight controls comprise trim controls and/or pitch trim switches and/or flap selector lever and/or speed brake lever and/or control pedals and/or pilot's stick.

12. The aircraft operating method of claim 9 wherein the aircraft maintenance operation comprises rigging and/or testing.

13. The aircraft operating method of claim 9 wherein the alternative operation of the controls comprises operating plural controls at the same time and/or operating plural controls each for longer periods than they are operated for flight.

14. The aircraft operating method of claim 9 wherein the alternative operation of the controls comprises performing a first predetermined sequence of inputs to select between rigging or testing, and performing a second predetermined sequence of inputs to select between rigging and/or testing submodes.

15. The aircraft operating method of claim 9 further including responding to an additional alternative operation of the controls to stop performing the aircraft maintenance operation.

16. A non-transitory memory storing instructions that when executed by at least one processor and/or processing circuit, controls the at least one processor and/or processing circuit to perform operations comprising:
receiving inputs from flight controls;
responding to the inputs from the flight controls by providing control surface commands to control flight; and
responding to alternative operation of the flight controls to select and perform an aircraft maintenance operation other than during flight.

17. The non-transitory memory of claim 16 wherein the operations further comprise communicating unidirectionally to provide feedback relating to the aircraft maintenance operation.

18. The non-transitory memory of claim 16 wherein the flight controls comprise trim controls and/or pitch trim switches and/or flap selector lever and/or speed brake lever and/or control pedals and/or pilot's stick.

19. The non-transitory memory of claim 16 wherein the aircraft maintenance operation comprises rigging and/or testing.

20. The non-transitory memory of claim 16 wherein the alternative operation of the controls comprises:
operating plural controls at the same time and/or operating plural controls each for longer periods than they are operated for flight, and/or
performing a first predetermined sequence of inputs to select between rigging or testing, and performing a second predetermined sequence of inputs to select between rigging and/or testing submodes.
